(19) United States
(12) Patent Application Publication
(10) Pub. No.: US 2017/0039390 A1
(43) Pub. Date: Feb. 9, 2017

(54) METHODS AND SYSTEMS FOR PRIVACY PRESERVING THIRD PARTY EXTENSION

(71) Applicants: James Alexander KING, Boca Raton, FL (US); Ken BARKER, Calgary (CA); Jalal KAWASH, Calgary (CA)

(72) Inventors: James Alexander KING, Boca Raton, FL (US); Ken BARKER, Calgary (CA); Jalal KAWASH, Calgary (CA)

(21) Appl. No.: 15/231,582

(22) Filed: Aug. 8, 2016

Related U.S. Application Data
(60) Provisional application No. 62/202,816, filed on Aug. 8, 2015.

(51) Int. Cl. G06F 21/62; G06F 9/445; G06F 17/30

(52) U.S. Cl. CPC G06F 21/6245; G06F 17/30902; G06F 8/61

(57) ABSTRACT

A computer-implemented method of preserving privacy of private user data using third party extensions on a web application platform is disclosed. The method includes receiving private and non-private user data from a user, providing non-private user data to a remote extension component, receiving remote extension data from the remote extension component and storing it on a local extension cache on the web application platform, providing private user data and remote extension data to a local extension component installed on the platform, executing local extension component instructions in a restricted operating system environment on the platform, receiving local extension data from the local extension component, and providing the local extension data to a user. A non-transitory computer-readable medium storing instructions to implement the method of preserving privacy of private user data using third party extensions on a web application platform, and a related system are also disclosed.

### CROSS REFERENCE TO RELATED APPLICATIONS

This application is related and claims priority to U.S. Provisional Patent Application Ser. No. 62/202,816 filed Aug. 8, 2015 and entitled “Methods and Systems for Privacy Preserving Third Party Extension”, which is hereby incorporated herein by reference in its entirety for all purposes.

### TECHNICAL FIELD

The present invention relates generally to methods and systems for data processing. More specifically, in one embodiment, the present invention relates to methods and systems for data processing that provide for preserving the privacy of user data that is being processed by one or more third party extensions.

### BACKGROUND

Internet enabled applications are a key part of our daily lives. In today's society, we complete many daily activities through internet enabled applications, such as making travel arrangements, banking, recording and reviewing medical records, storing and sharing photos, and connecting with friends through social networking. Internet enabled applications run on various types of computer servers, with the vast majority of them located remotely from the end users that utilize their services.

In the past, when end-users required new features from an internet enabled application, the company or organization responsible for the application had to implement the features in-house. Due to the complexity and resources required to implement additional features in-house, software developers created extension architectures. Extension architectures allowed third parties to provide additional features to the application through the use of third-party extensions which are also commonly referred to as plug-ins or plug-in features.

Typically, plug-in features are installed on a user computing device and used at the user's own risk. Basic extension architectures allow plug-in features to interact directly with the original application to provide additional features, which may include obtaining previously stored private and non-private information about the user from the original application.

Current methods for preserving privacy typically rely on data security theories and methodologies. For example, a commonly known method to maintain privacy provides for implementing access control to data and cryptography to encrypt data when it is transferred between applications and extensions. Under such methods, users may typically provide consent to release their private information to third-party extensions and the transmission of private data to the third party may typically be encrypted. In these systems typically the transmission of private data to the third party does not then violate the privacy of the user since the user has consented to the release of their private information. This method of preserving privacy is commonly known as consent-to-use.

However, under certain such known systems, there remains a risk that a third party accessing the user's information is an adversary or untrusted entity, or may act for interests which are not aligned with those of the user. In addition, with transfer of user data to third parties there may typically also be risks of interception. Therefore, typically the transmission of private user information to the third party inevitably increases the risk of a privacy violation.

Accordingly, there remains a desire for a privacy enabling system where a third party extension may desirably implement additional features to an internet-enabled application without increasing the risk of a privacy violation or necessarily requiring release of private user information to the third-party extension developer from the original internet-enabled application.

### SUMMARY

It is an object of the present invention to provide a method and system for preserving data privacy for third party extensions providing features to internet-enabled applications that addresses some of the limitations of the prior art.

Another object of the present invention is to provide a system comprising a computer-readable memory module comprising computer-readable instructions for preserving data privacy for third party extensions providing features to internet-enabled applications that addresses some of the limitations of the prior art.

It is a further object of the invention to provide a tangible, non-transitory computer-readable storage medium comprising computer-readable instructions for preserving data privacy for third party extensions providing features to internet-enabled applications that addresses some of the limitations of the prior art.

According to one embodiment of the present invention, a computer-implemented method of preserving privacy of private user data using third party extensions on a web application platform is provided. In such an embodiment, the method comprises executing on at least one computer processor the steps of:

receiving private and non-private user data from a user on the web application platform;

providing non-private user data to a remote extension component executing on a third party computer processor;

receiving remote extension data from the remote extension component and storing the remote extension data on a local extension cache on the web application platform;

providing private user data and remote extension data to a local extension component installed on the web application platform;

executing local extension component instructions in a restricted operating system environment on the web application platform and receiving local extension data from the local extension component; and

providing the local extension data to a user.

According to a further embodiment of the present invention, in the above method of preserving privacy of private user data using third party extensions on a web application platform, the restricted operating system environment may be configured to prevent communication between the local extension component and any computer processor or electronic device outside the web application platform, or may be configured to prevent transfer of private user data outside of the local extension cache.

According to another embodiment of the invention, a non-transitory computer-readable medium storing computer-executable instructions to implement a method of preserving privacy of private user data using third party extensions on a web application platform is provided. In such an embodiment, the non-transitory computer-readable medium may comprise computer-executable instructions to:

receive private and non-private user data from a user on the web application platform;

provide non-private user data to a remote extension component executing on a third party computer processor;

receive remote extension data from the remote extension component and store the remote extension data on a local extension cache on the web application platform;

provide private user data and remote extension data to a local extension component installed on the web application platform;

execute local extension component instructions in a restricted operating system environment on the web application platform and receive local extension data from the local extension component; and

provide the local extension data to a user.

According to yet another embodiment of the invention, a system for preserving privacy of private user data using third party extensions on a web application platform is provided. In one such embodiment, the system may comprise:

at least one computer processor;

at least one network interface;

a non-transitory computer-readable memory module; and

computer-readable instructions stored in the computer-readable memory module, wherein the computer-readable instructions when executed, are operable to configure the at least one computer processor to:

receive private and non-private user data from a user on the web application platform;

provide non-private user data to a remote extension component executing on a third party computer processor;

receive remote extension data from the remote extension component and store the remote extension data on a local extension cache on the web application platform;

provide private user data and remote extension data to a local extension component installed on the web application platform;

execute local extension component instructions in a restricted operating system environment on the web application platform and receive local extension data from the local extension component; and

provide the local extension data to a user.

Further advantages of embodiments of the invention will become apparent when considering the drawings in conjunction with the detailed description.

### BRIEF DESCRIPTION OF THE DRAWINGS

The present invention is described with reference to the accompanying drawing figures, in which:

FIG. 1 illustrates a schematic diagram of a basic conventional third party extension architecture according to the prior art.

FIG. 2 illustrates a schematic diagram of an exemplary privacy preserving third party extension architecture according to one embodiment of the present invention.

FIG. 3A illustrates an information flow chart depicting an exemplary data communication model according to one embodiment of the invention.

FIG. 3B illustrates an exemplary series of operations associated with an embodiment of the present invention.

FIG. 4A illustrates an information flow chart depicting exemplary extension component communication according to one embodiment of the invention.

FIG. 4B illustrates exemplary extension component partition architecture configurations according to embodiments of the present invention.

FIG. 5 illustrates a functional information flow diagram depicting exemplary extension component and data communication according to an embodiment of the invention.

FIG. 6 illustrates a communication protocol for installing a local extension component within an exemplary privacy extension architecture in accordance with an embodiment of the invention.

FIG. 7A illustrates an exemplary mutual authentication procedure initiated by a web application platform, associated with an embodiment of the present invention.

FIG. 7B illustrates a further mutual authentication procedure initiated by a third party extension, associated with a further embodiment of the invention.

FIG. 8 illustrates a functional block diagram of an exemplary web application platform configuration according to an embodiment of the invention.

Like reference characters refer to corresponding parts throughout the several views of the drawings.

The examples set out herein illustrate several exemplary embodiments of the invention but should not be construed as limiting the scope of the invention in any manner.

### DETAILED DESCRIPTION

In the present disclosure and in the art, extension architectures developed by third parties to provide additional features to web applications may be commonly and interchangeably referred to as “third-party extensions”, “plug-ins”, “plug-in features”, “^{3rd} party extensions”, or simply “extensions”.

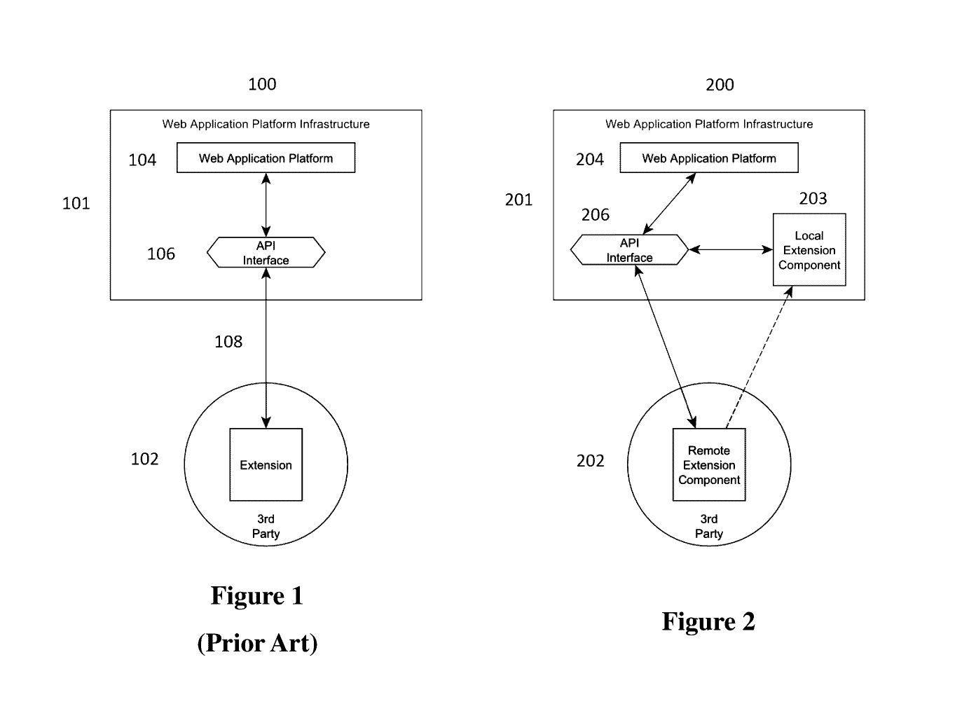

Referring to FIG. 1, a schematic diagram of a basic conventional third party extension architecture 100 is shown, as is known in the prior art. The conventional extension architecture 100 comprises a web application platform infrastructure 101 and a third party extension component 102. The web application platform infrastructure 101 typically comprises a web application platform 104 (also known as simply a web application) and an application programming interface 106 (hereinafter referred to as “API Interface”) which may typically be adapted to enable communication between the web application platform 104 and external applications or extension components.

Web application platform infrastructure 101 may typically have controlled communication capabilities to desirably limit communication to and from the web application platform infrastructure, such as to provide for control of what types of data are permitted to be transmitted and received by the web application platform infrastructure 101 and between its components and outside third party computers or systems. As shown in FIG. 1, web application platform infrastructure 101 may typically communicate with third party applications running on third party computer systems outside web application platform infrastructure 101 (and which may be controlled by third party entities separate from and potentially adverse in interest to those of the web application platform infrastructure 101) through API Interface 106.

A conventional web application platform 104 may typically comprise a computer system such as one or more computer servers, and/or cloud servers. The web application platform 104 may typically provide features which may include storing private and non-private information such as private and non-private user data from one or more end users of the web application, computerized analysis and processing of private and non-private information, business/recreational/communication functions provided to users, in-house applications, website or web application interaction capabilities, reporting, data security, and the like, for example. In some aspects, a conventional web application platform 104 may typically comprise at least one internet enabled computer server, typically comprising a database, processor, memory, and a user interface.

Conventional API Interface 106 may typically provide or expose programming functions to one or more third party extension module 102 such that a third party extension 102 may interact and communicate with the web application platform 104. A typical API Interface 106, may generally provide a plethora of software functionality in terms of allowing a range of operations, inputs and outputs in connection with the web application platform 104. For example, using a conventional API Interface 106, a conventional third party extension 102 may commonly retrieve private and non-private information (such as private and non-private user information) from the database of the web application platform 104.

As shown in FIG. 1, in conventional systems, information may be transferred to and from a third party extension 102 to the web application platform 104 through the API Interface 106. When any private information is transferred outside the web application platform infrastructure 101 in a conventional system, the risk of privacy loss in relation to private information is typically increased both through the possibility of interception of private information in transit on the internet or other third party communication network, or through an action or negligence of an untrustworthy conventional third party extension or unsecured third party system. As discussed in general above, current conventional systems may not consider such data communication or transmission of private information to outside parties which may result in a loss of privacy to constitute a privacy violation because a conventional extension architecture 100 typically requires users to consent to transmission of private user data to the third party extension 102. Accordingly, although a user may have provided consent or permission to transfer private user data to a third party extension 102 in order to obtain access to extension functionality on an internet-enabled application on the web application platform 104, an undesirable privacy loss resulting from transmission of private user data to a third party extension 102 may still occur, even if it may not be considered to be a privacy violation under the consent policy applied by the conventional extension architecture 100. Such potential for privacy loss in a conventional third party extension architecture 100 may comprise an undesirable limitation from the perspective of a user.

Referring to FIG. 2, a schematic diagram of an exemplary privacy preserving third party extension architecture 200 is shown, according to one embodiment of the present invention. As shown in FIG. 2, privacy protecting extension architecture 200 comprises a web application platform infrastructure 201 and third-party remote extension component 202.

Web application platform infrastructure 201 comprises web application platform 204, API interface 206, and at least one local extension component 203 (of which one exemplary such local extension component 203 is shown). Web application platform 204 may be substantially similar to web application platform 104 previous disclosed, and desirably provides for access to an internet-enabled or other networked or connected application by one or more users (not shown), and further provides for additional features or functionality in connection with an internet-enabled application to be provided through interface with a third party extension provided by a third party. In the embodiment shown in FIG. 2, the third party extension comprises a remote third party extension component 202 which may typically execute on a third party system separate from web application infrastructure 201 (such as on a third party computer server, processor, network or distributed cloud platform, for example), and a local extension component 203, which may typically be installed and execute on the web application infrastructure 201, such as web application platform 204, for example.

In an embodiment illustrated in FIG. 2, third party developers may create one or more of local extension components 203 and/or remote extension components 202 for interacting with the web application platform 204 such as to provide for additional features or functionality in an internet-enabled application on the web application platform 204. In one embodiment, local extension component(s) 203 may comprise one or more third party extension module which may desirably be limited in its operation so as to prevent transfer of information (such as user data which may be accessible or stored by the web application platform 204) outside of the internal realm of the web-application platform infrastructure 201. In one such embodiment, local extension component 203 is operable to communicate with web application platform 204 through API 206, such as to transmit and receive data to/from web application platform 204. In some embodiments, local extension component 203 may also receive or otherwise be provided information from the external realm outside web application platform infrastructure 201, such as by receiving data from remote extension component 202, for example. However, in one such embodiment, local extension component 203 may desirably be limited to prevent transmission of any data from local extension 203 to the external realm, such as to remote extension component 203.

In some embodiments, local extension components 203 may be treated as in-house applications with respect to the web application platform 204, that is, an application that is provided with substantially similar privileges and permissions (such as data access permissions and/or system resource access permissions for example) to those granted to other features or applications implemented in-house on web application platform 204, and which may typically be provided and/or implemented natively on web application platform 204 by the internet-enabled application developer or operator of the web application platform 204, for example. In other embodiments, local extension component 203 may be given enhanced privileges and permissions relative to a remote extension component 202 but still fewer privileges and permissions than may be provided to an in-house application developed and hosted through the web application platform 204.

In some embodiments, third party developers may develop remote extension components 202, such as to provide additional features and/or functionality to internet-enabled applications running on and/or hosted by web application platform 204. As is further detailed below, in one aspect, remote third party extension components 202 may desirably have limited access to information stored within web application platform 204 or accessible by web application platform 204. In one such embodiment, the web application platform information may comprise data, such as user data, which may be stored in memory/storage modules connected to web application platform 204 such as in a web application database (not shown in FIG. 2). In one embodiment, a web application database may be physically located with web application platform 204 or alternatively may be remotely located or distributed (such as in the case of cloud storage) and accessibly connected to web application platform 204.

In a particular embodiment, access to web application platform 204 provided to the remote extension component 202 (such as may be controlled by the API interface 206 for example) may be configured similarly to as in previously described 3rd party extension component 102. In such an embodiment, remote extension component 202 may be provided access only to information, such as user data, to which the user has consented or provided permission for the third party remote extension component 202 to access (such as through agreement to a privacy policy governing third party extensions or other permission control mechanism, for example). In some embodiments, information (such as user data) to which access is provided to remote extension component 202 may be limited to only non-private user data.

In one embodiment according to the present invention, web application platform infrastructure 201 desirably provides communication control for all information communicated to/from remote extension component 202 and local extension component 203, such as through a central web application server (not shown) for example. In one embodiment, one or more local extension components 203 are installed by the application developer onto the web application platform 204, such as onto one or more web application platform servers. In one such embodiment, the web application platform 204 desirably controls the communication ports, operating system and file system access, as well as the interfaces the local extension component 203 can use and interact with, such as through API interface 206, for example.

In one particular embodiment, local extension components 203 may be installed in and their execution may be limited to within a restricted operating system environment so as to more specifically control access to information and system resources on web application platform 204, for example. In one such embodiment, a restricted operating system environment may comprise one or more of a virtualized operating environment (such as a virtual machine or virtualized execution instance) and a sandboxed environment. In a particular embodiment, a sandboxed environment may comprise a sandbox running natively on the web application platform 204, or other known sandboxing operating environment technique or application, for example. In certain such embodiments, the installation and execution of local extension components 203 may be limited to within a restricted operating system environment to desirably manage and limit any communication of information between the local extension component 203 on the web application platform 204, and the remote third party extension component 202 on a third party system. In one embodiment, the local extension component 203 may prohibited from transferring any information (such as may contain user data) to the remote extension component 202. In one aspect, the local extension component 203 may be allowed to retrieve both sensitive end-user data and private end-user data from the web application platform 204 for processing strictly within the web application platform architecture 201. In another aspect, wherein user data on web application platform 204 may comprise both private and non-private (may also be referred to as “sensitive user data”) data, the remote extension component 202 may be specifically prohibited from retrieving or otherwise accessing any private end-user data from the web application platform 204 so as to reduce a risk of privacy loss or violation, but may be provided controlled access to certain non-private user data, such as non-private user data to which a user has consented to allow third party extension access. In one such embodiment, the local extension component 203 may be permitted to retrieve both private and non-private end-user data from web application platform 204, but may be prohibited from transmission of any private user data or even any data whatsoever outside of the web application platform architecture 201. In such embodiments, the ability to restrict access to any private user data by any system outside the web application platform infrastructure 201 may desirably provide for preservation of privacy of private user data, for example.

In an alternative embodiment, information to be protected may comprise classified and non-classified information such as in government records systems, or may comprise information with varying data security levels such as low, medium or high data security levels, or other suitably defined data security levels, such as within a corporate or private network system. In certain such alternative embodiments, classified and non-classified information, or information having different data security levels may be identified as to its classification level and/or data security level by a user, or system administrator, or existing data classification or security assignment system. In such embodiments, the web application platform 301 may alternatively comprise an internal application platform, or data storage system application platform which may comprise local or trusted extension components, and remote or untrusted extension components. In certain such embodiments, the application platform infrastructure 201 may be configured to prevent transmission of any classified data or data of a selected data security level from being transmitted outside the application platform infrastructure 201, such as to untrusted extension components or remote extension components not authorized to receive such classified or data security level information, for example.

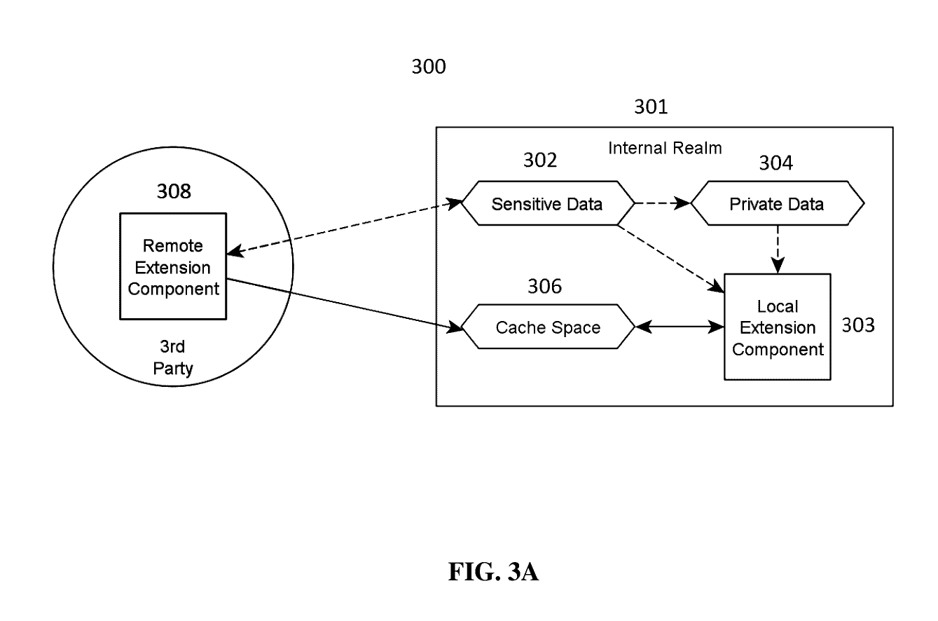

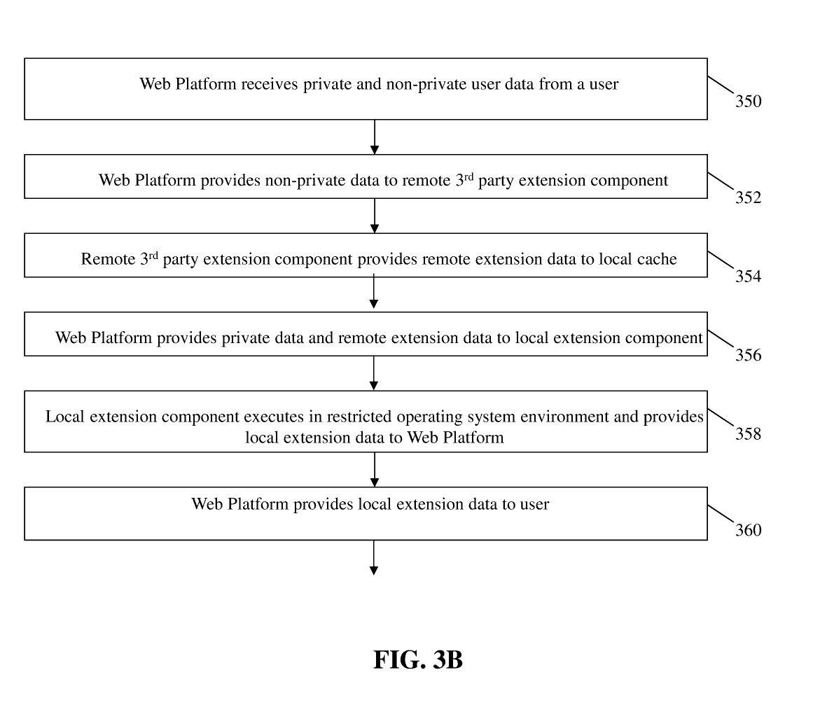

Referring to FIG. 3A, an information flow chart depicting an exemplary data communication model for a privacy preserving architecture 300 incorporating a third party extension is shown, according to an embodiment of the invention. In one embodiment, the privacy preserving architecture 300 is divided into an internal realm which is within a web application platform 301 and under the control of the platform, and an external realm that is outside the web application platform 301 and includes all third party systems such as third party remote extension component 308, for example. In one such embodiment, the internal realm within web application platform 301 may comprise non-private or sensitive data 302 (such as non-private user data), private data 304 (such as private user data), local cache space 306 for locally storing private 304 and sensitive or non-private 302 data such as for controlled access by extension components, and at least one local extension component 303 (of which one exemplary local extension component is shown). The Internal realm within control of the web application platform 301 comprises trusted components, that is, components that may access private data 304 (such as private user data) and cannot transmit private data 304 beyond the internal realm.

In one such embodiment, user information is stored within web application platform 301 and is divided into sensitive or non-private data 302 and private data 304. Private data 304 differs from sensitive or non-private data 302 in that private data 304 cannot be transmitted beyond the internal realm of web application platform 301 or a virtual sandbox or other restricted operating system environment running within the web application platform 301, in order to preserve the privacy of the private data 304. In some embodiments, user information may be identified as sensitive 302 or private 304 data according to a flag or other marker, and may be specified as sensitive or private by the user or the application developer, such as when the data is initially stored (or received from a user in the particular case of user data). In some embodiments, sensitive data 302 and private data 304 may be stored in separate databases and/or database tables to distinguish between the two data types and their required treatment for the purposes of protecting privacy and preventing privacy violations.

As shown by the arrows denoting communication connections illustrated in FIG. 3A, local extension component 303 may retrieve information from sensitive data 302, private data 304 and the local cache space 306. Local extension component 303 may write data into the local cache space 306, such as for use during computation related to the provision of extension functions and services. In some embodiments, private data 304 may not be fully accessible by local extension component 303, depending on the privacy policy or privacy rules associated with certain private data 304, as may be implemented by the application developer or operator, or the user. In one such embodiment, local extension component 303 may require user consent or permission to be indicated prior to being given access to the private data 304 or some subset of private data 304. In some embodiments, local extension component 303 may require memory and/or storage space such as for computation use during provision of extension functions or services. In one such embodiment, local extension component 303 may write and retrieve information into the local cache space 306, which is within the internal realm of the web application platform 301. In one embodiment, local cache space 306 may comprise any suitable memory or data storage facility or resource located within the internal realm and authorized for storage of private and/or non-private information, for example.

As also shown in the one embodiment illustrated in FIG. 3A, at least one remote extension component 308 (of which one exemplary remote extension component is shown) may retrieve sensitive data 302 into the external realm, since sensitive or non-private data 302 is not restricted for communication with extension components outside the internal realm of web application platform 301. In one such embodiment, remote extension component 308 may also write information into sensitive data 302 and local cache space 306. As depicted by the single sided arrow as shown in FIG. 3A, remote extension component 308 may store information into the cache space 306, however, remote extension component 308 is not permitted to retrieve or otherwise access any information from local cache space 306 (which may comprise sensitive and private data), as remote extension component 308 is not a trusted component and is on a third party system in the outside realm apart from web application platform 301. In some embodiments, the local cache space 306 may be used by a remote extension component 308 to update a local extension component 303, such as by periodically writing updated extension data to local cache space 306, but in such embodiments, updated extension data may be retrieved from local cache space 306 only by local extension component 303, since remote extension component 308 is prohibited from accessing or retrieving data from local cache space 306, for the purposes of preserving privacy of any potentially private data 304 which may be stored in local cache space 306, for example. Accordingly, preventing access to the local cache space 306 and private data 304 by any agent in the external realm outside web application platform 301 may desirably provide for improved preservation of privacy of private data 304 in the exemplary privacy preserving web application architecture 300.

It should be appreciated that the components illustrated in privacy preserving web application platform architecture 300 are intended to be exemplary in nature, and that additional or alternative components and/or modules can be included. It should also be appreciated that the functions of the illustrated exemplary components may be combined or distributed. In addition, a function of a component need not be performed on a single computer or device, instead, the function may be distributed across a network to one or more other computers and/or devices such as within a network of servers or other computers comprising the internal realm of web application platform 301 if desired, for example. It is the functions of the illustrated embodiments that are significant, not where they are performed or the specific manner in which they are performed.

FIG. 3B illustrates an exemplary series of operations associated with an embodiment of the present invention. In one embodiment, the series of operations illustrated in FIG. 3B may be implemented by a privacy preserving web application platform architecture such as the exemplary architecture 300 shown in simplified form in FIG. 3A. The first operation 350 of FIG. 3B comprises a web application platform receiving private and non-private (also referred to as sensitive) user data from a user. The private and non-private user data may be received by web application platform 301 such as from individual users, or from a repository storing user information, for example. In the second operation 352 of FIG. 3B, the web application platform provides non-private data to a remote extension component. In one such embodiment, the non-private or sensitive data 302 may be provided to a remote extension component 308 over a connected computer system such as a computer network which may be a wired or wireless network or the internet, or within a shared file system, software development network (SDN) or other internal network, for example, to connect the internal realm of the web application platform 301 with the remote extension component 308 on a third party system in the external realm outside web application platform 301.

In the third operation 354 of FIG. 3B the remote extension component provides remote extension data to a local cache. In one such embodiment, the remote extension data may comprise data processed or retrieved by the remote extension component 308 in order to provide additional functionality and/or services by the third party extension, or that may be required for further processing by the local extension component 303 within the internal realm of the web application platform 301, for example. In one embodiment it is an explicit requirement that while the remote extension component 308 may provide data to the local cache 306, it cannot access or retrieve data from the local cache 306, so as to desirably provide for preservation of privacy of private information within the web application platform 301.

In the next operation 356 of FIG. 3B, the web application platform provides private data and remote extension data to the local extension component. In one such embodiment, private data 304 and remote extension data from local cache space 306 may be provided to the local extension component 303 for processing within the web application platform 301.

In the next operation 358 of FIG. 3B, the local extension component executes within a restricted operating system environment and provides local extension data to the web application platform. In one such embodiment, the local extension component 303 may execute within a sandbox (such as a natively supported sandbox or other suitable sandboxing application or tool running within the web application platform 301) or virtualized restricted operating system running on the web application platform, so as to desirably prevent any potential access from outside the web application platform 301 to the private data. In a particular such embodiment, local extension data (such as the processed data required to provide the third party extension functionality or services to a user) may be provided to the web application platform 301 by storing it in local cache 306, or by otherwise storing the local extension data output on the web application platform 301.

In the final operation 360 of FIG. 3B the web application platform (or optionally the local extension component directly) provides the local extension data to a user. In a particular embodiment, the local extension data provided to a user may comprise the result or solution of a function or service provided by the third party extension. In an alternative embodiment, the local extension data may first be stored, further processed, or otherwise modified within the web application platform 301 before it is provided to a user.

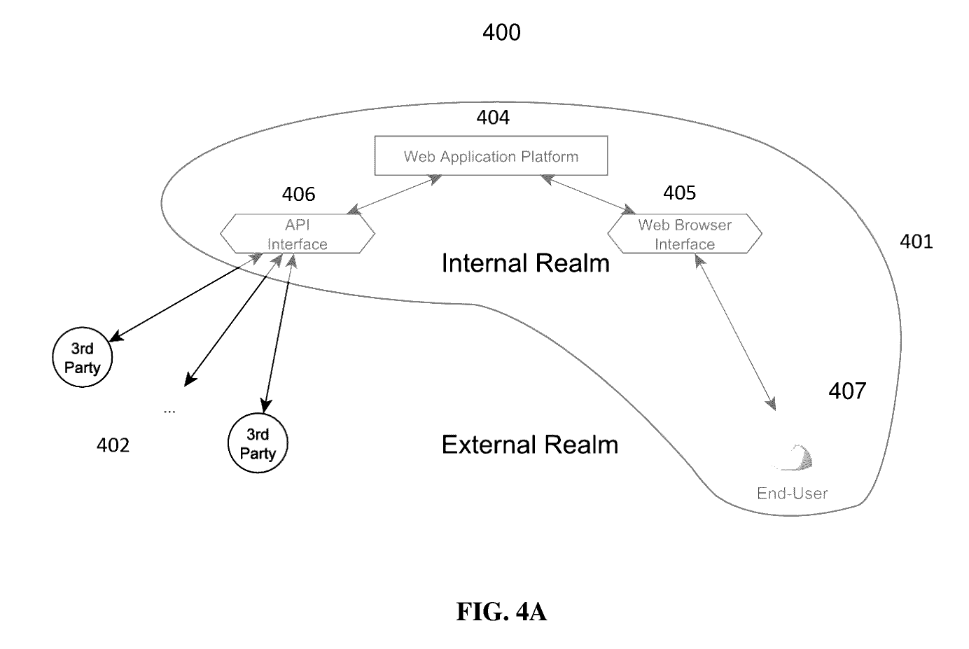

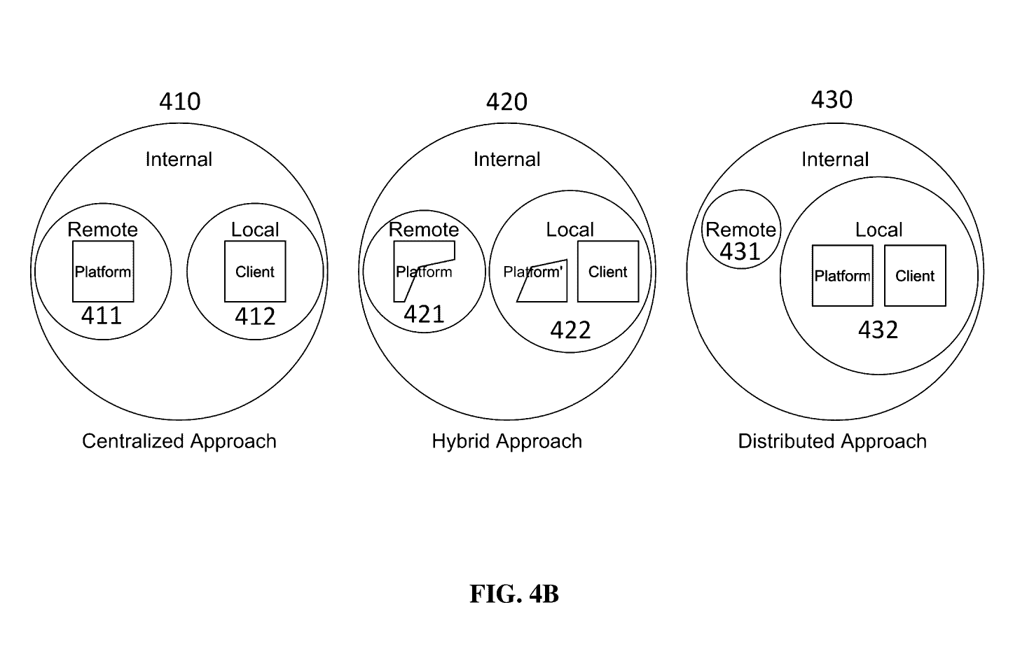

Referring to FIG. 4A, an information flow chart depicting exemplary extension component communication is shown, according to one embodiment of the invention. Similar to as described in reference to FIG. 3A above, exemplary components of a privacy preserving web application platform architecture 400 are shown, divided into an internal realm 401 comprising the web application platform 404, API interface 406, and a web browser interface 405 such as to allow for connection and access to a user 407, and an external realm 402 comprising one or more third party extension components such as may run on third party systems.

Similar to as discussed above in reference to FIG. 3A, FIG. 4A shows information interaction among components according to one exemplary embodiment of the invention. As shown in the exemplary embodiment of FIG. 4A, a user 407 may access, upload, and update their private and sensitive (or non-private) data to the web application platform 404, such as through a web browser interface 405. In some embodiments, the web browser interface 405 may comprise one or more of a mobile application, a desktop application or any suitable type of human-computer interface to provide for interaction with a user 407. In one embodiment, the web-browser interface 405 may comprise a local extension component or an in-house application within the web application platform 404.

As shown also in the exemplary FIG. 4A embodiment, one or more third party remote applications 402 may interact with internal realm 401 through the API interface 406. In exemplary embodiments discussed above with reference to FIGS. 2 and 3A, third party remote extension components have been depicted as optionally interacting with local extension components (providing data to local extension component in FIG. 2), and sensitive data 302 and cache space 306 (FIG. 3) directly. In accordance with one embodiment, it should be understood that in general, and in lieu of alternative mechanisms capable of enforcing the necessary security requirements restricting transmission of private data outside the web application platform internal realm, that the remote extension component would typically interact with other components within the web application platform 404 and internal realm 401 through the API Interface 406.

With reference to FIG. 4B, exemplary extension component partition architecture configurations 410, 420 and 430 are shown, according to embodiments of the present invention. FIG. 4B depicts three exemplary configurations of the web application platform as may be representative of a range of optional configurations under embodiments of the invention. In a first centralized approach configuration 410 according to one embodiment, the web application platform runs on its own hardware (“server-side” 411) and users utilize a client interface 412 (e.g., a web browser or mobile application or the like) to interact with the platform. In an exemplary distributed approach configuration 430 according to another embodiment, there are no web application platform components running on the server-side 431, but instead the entire platform runs on the client-side 432 such as on a local client application running on a user device, for example. In a hybrid approach configuration 420 according to yet another embodiment, some components of the platform are run on the server-side 421 and some are run on the client-side 422 such as on a user device. In all three of these exemplary embodiments as shown in FIG. 4B, it is intended that principles of the invention may be applied to desirably provide for preservation of privacy and information flow control policies for the end-user to desirably provide for protection against potential violations of privacy in interactions with third-party extensions.

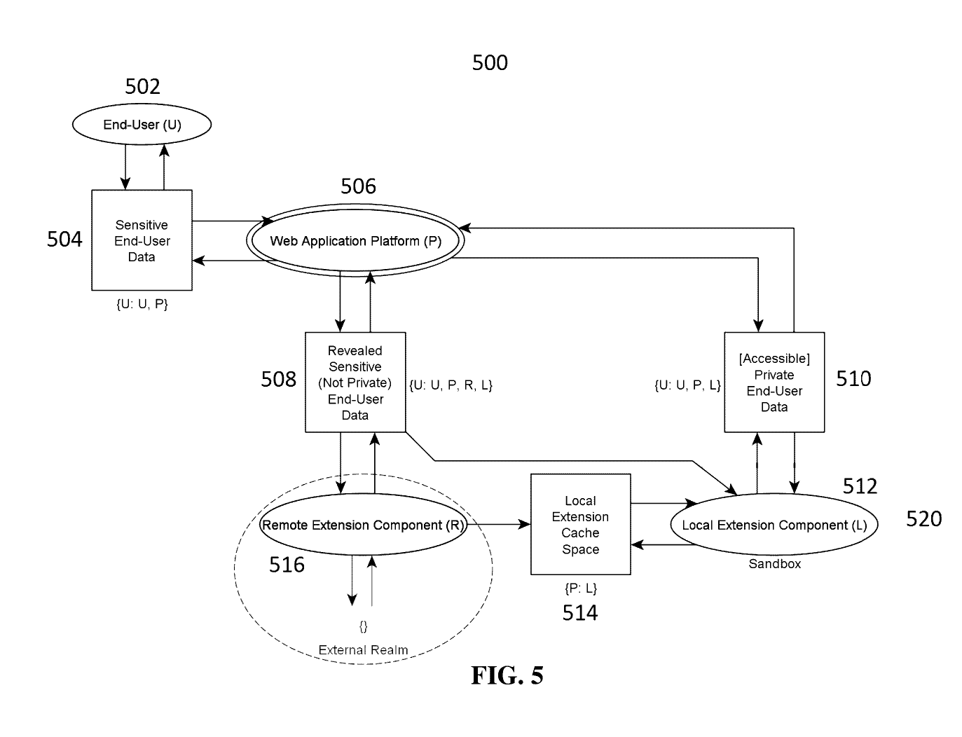

Referring now to FIG. 5, a functional information flow diagram depicting exemplary extension component and data communication in an exemplary web application architecture 500 is shown, according to an embodiment of the invention. In one embodiment, an end-user 502 (also referred to interchangeably as a user) may provide sensitive end-user data 504 to the web application platform 506. End-user 502 may for example add or delete their own sensitive end-user data 504, as well as designate what data may be revealed to third parties (e.g. designated as sensitive or non-private end-user data 508) and what data is private (e.g. private end-user data 510) and to be protected from third parties. Web application platform 506 may be configured similarly to web application platform 204, 301 and 404 as previously described in reference to FIGS. 2, 3A and 4A. For clarity, the API Interface in FIG. 5 has not been shown.

In one embodiment, remote extension component 516 is similar to remote extension components 202 and 308 as described above. Remote extension component 516, part of the external realm and run on a third party system, may in one embodiment be authorized to access and write sensitive end-user data 504 based on its security access level. In some embodiments, remote extension component 516 may be authorized to write only to a local extension cache space 514 that a local extension component 512 may read. As described above, in a particular embodiment, such write only access of the remote extension component to the local extension cache space 514 may desirably provide for a third party developer to update data available to the local extension components 512, such as to provide for local extension functions and/or algorithms.

In one embodiment, the local extension component 512 has limited or otherwise specifically restricted write privileges. The local extension component may write into either a local extension cache space 514 or private end-user data 510. In such an embodiment, this restricted write access ensures that the local extension component 512 may not communicate private end-user data 510 to the external realm (such as to the remote extension component 516 or any other third party system).

In one embodiment, local extension component 512 may be similar to local extension component 203 as described above, except that local extension component 512 may be installed on or run from an external computer server separate from the web application platform 506. In some embodiments, local extension components 512 could be installed on an end-users web browser, personal computer, mobile device and/or another external computer server. In one such embodiment, a sandbox 520 or other suitable restricted operating system environment (such as a virtualized environment for example or a restricted network or communication environment) may be utilized to maintain the privacy of private end-user data 510 within the internal realm and restrict transmission of any private end-user data 510 outside of the internal realm.

In one such embodiment, sandbox 520 may be used to provide a virtual barrier around local extension components 512, such as to prevent code running within the sandbox 520 from interacting or communicating with any system or software components outside the sandbox 520 and internal realm. In one embodiment, sandbox 520 may be implemented using a native sandbox functionality such as that provided for in certain programming tools and/or protocols such as in Python 2.7. In one such embodiment in Python 2.7, the command “exec code in scope” may desirably be used to create a sandbox 520 to protect against code using unwanted functionality from within Python. In such an embodiment, the built-in functions desired to be prevented from access by code executing within the sandbox 520 may be removed from the “scope”. In other embodiments, other suitable sandbox implementations of sandbox 520 may utilize a purpose built sandbox such as heavier pysandbox library or code from the Seattle Project, which is hereby incorporated by reference, for example. In one such embodiment, Pysandbox may provide for a Python sandboxing library that allows for extensive customization and control over sandboxed code. In another embodiment, sandboxing code may be used from The Seattle Project, which is an exemplary distributed computing platform that utilizes sandboxing to enable untrusted code to run on machines donating their computational resources. In yet other embodiments, a sandbox may be provided by using computer virtualization, and virtualization technologies such as QEMU or Xen may be used to provide sandboxing functionality for implementation of sandbox 520.

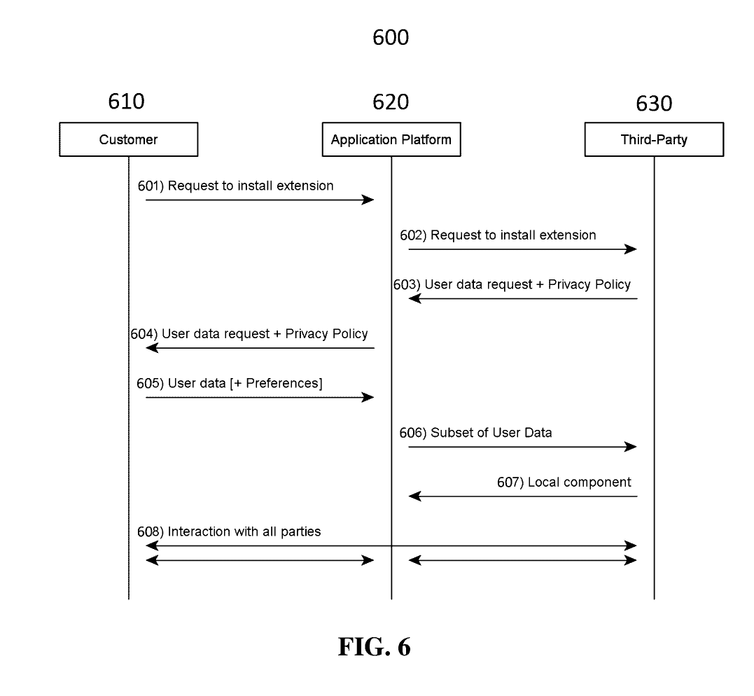

Referring now to FIG. 6, a functional information flow diagram depicting exemplary extension component and data communication is shown, according to an embodiment of the invention, and depicts an exemplary communication protocol 600 among entities for installing a third party extension component from a third party 630 on a web application platform 620. As shown in the exemplary embodiment depicted in FIG. 6, a customer 610 wishing to install a third party extension begins by submitting a request 601 to the web application platform 620 to install a third party extension. The application platform 620, within the internal realm of the platform or a sandbox, makes a request 602 to the corresponding third party 630 to install a third party extension. The third-party extension may comprise a remote extension component or local extension component or both, as is discussed above in several embodiments.

In one embodiment, in response to the request 602, the third party 630 returns a privacy policy and user data requests 603 to the application platform 620, such as to obtain data and/or appropriate consent from the customer 610 or other user(s). The application platform 620 then sends or forwards a privacy policy and user data request 604 to the customer 610 and optionally to other user(s). In some embodiments, consent may not be required for access to private data by local component extensions such as those executing within the internal realm of application platform 620 or a restricted operating system environment such as a sandbox, for example.

In one embodiment, the customer 610 may then select the sensitive and private data that it wishes local and remote extension components to have access to, and to send such selections of private and sensitive (or non-private) user data 605 (optionally also including user preferences and/or privacy rules associated with such user data) to the application platform 620. The application platform 620 then sends a subset of approved or permitted sensitive user data 606 to the third party developer 630 and the local extension component 607 is returned to the application platform 620 to be installed in the internal realm of the platform 620 and/or within the sandbox. Thereafter, interaction 608 may proceed between the parties in accordance with the privacy and access controls and rules established in the protocol 600.

In some embodiments, while the local extension component 607 is installed within a sandbox, private data may be transmitted via the internet or other communication network from the application platform 620 to the third party local extension component. In some embodiments, data transfer such as between the application platform 620 and a local extension component may be facilitated by a mutual authentication procedure. In such embodiments, the mutual authentication procedure may desirably allow the third party extension 630 and the web application platform 620 to verify the party performing a request for data, such as to provide for improved security of such data transfer.

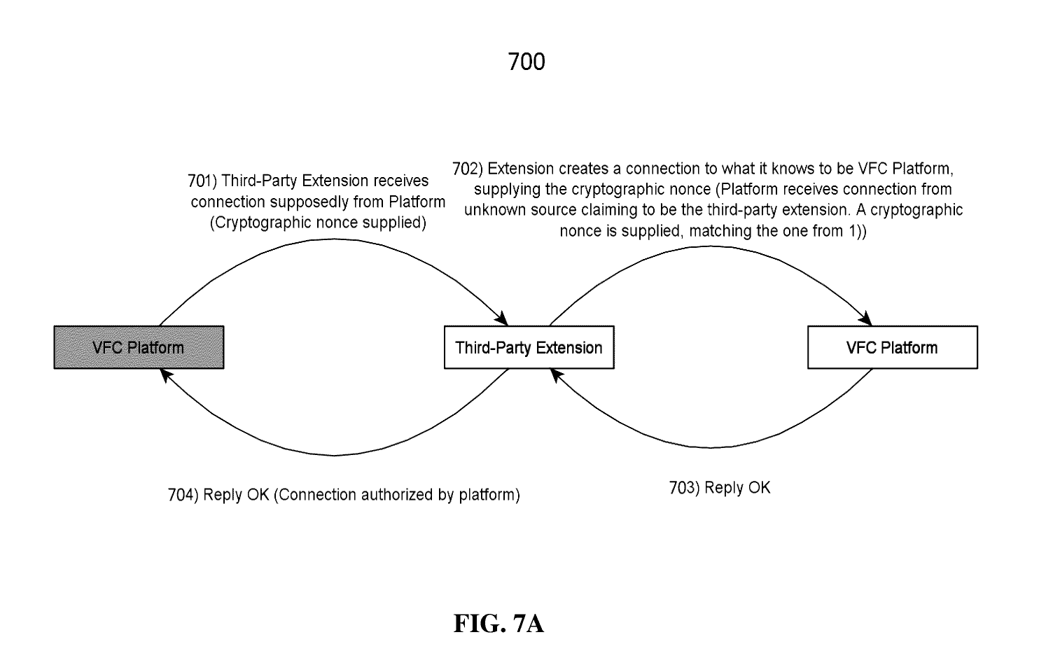

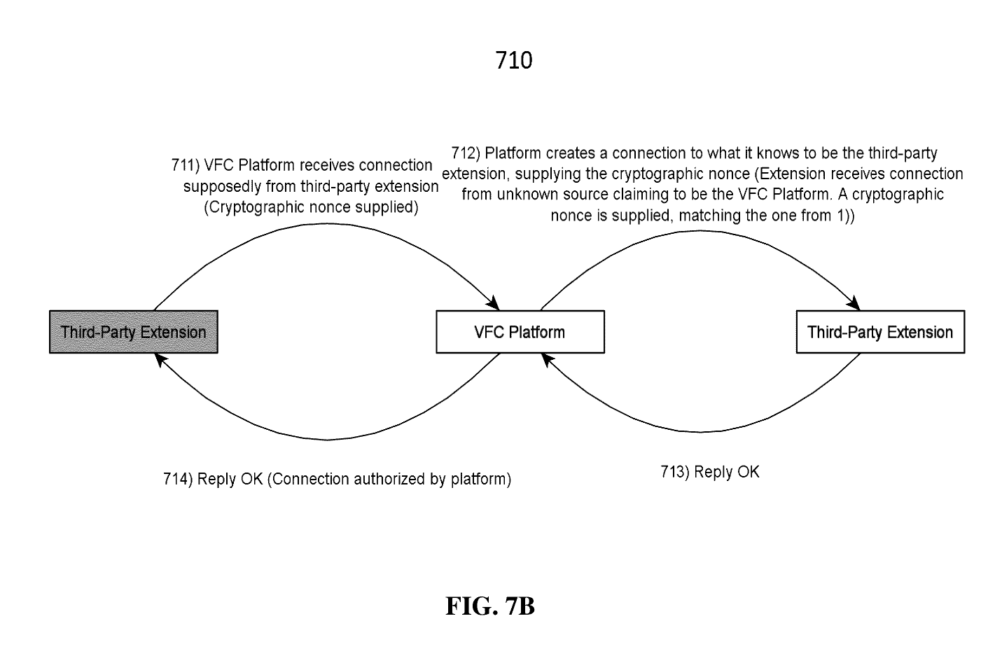

Referring to FIGS. 7A and 7B, two exemplary mutual authentication procedures 700, 710 are shown, in accordance with embodiments of the present invention. FIGS. 7A and 7B depict similar communication protocols, however, the party making the initial connection request differs. In the exemplary embodiment shown in FIG. 7A, the web application platform (also referred to as VFC platform) initiates the initial connection request, while in the exemplary embodiment FIG. 7B, the third-party extension makes the initial request.

In the exemplary embodiment illustrated in FIG. 7A, when a connection 701 is first received by the third party extension from the unverified application platform, a cryptographic “nonce” or suitable one-time use or unique cryptographic identifier is provided to the third party extension. Then the third party extension makes a connection 702 back to the claimed connecting party (the platform) providing the same cryptographic nonce or identifier, in order to verify the connection. Following that, the application platform may then send a confirmatory reply 703 to the third party extension, and the third party extension then confirms a positive reply 704 to the platform, at which point both parties can verify the identity of the counterparty to the connection and the platform can authorize the connection for data communication with the third party extension.

In the exemplary embodiment illustrated in FIG. 7B, the mutual authentication procedure 710 proceeds similarly, but where the initial request 711 is made from the third party extension to the application platform. In the FIG. 7B embodiment, when a connection 711 is first received by the platform from the unverified third party extension, a cryptographic “nonce” or suitable one-time use or unique cryptographic identifier is provided to the platform. Then the platform makes a connection 712 back to the claimed connecting party (the third party extension) providing the same cryptographic nonce or identifier, in order to verify the connection. Following that, the third party extension may then send a confirmatory reply 713 to the platform, and the platform then confirms a positive reply 714 to the third party extension, at which point both parties can verify the identity of the counterparty to the connection and the platform can authorize the connection for data communication with the third party extension.

In one embodiment, the outgoing connection to verify a user may be completed using the HTTP protocol over Transport Layer Security. Using TLS may desirably allow the receiver to be assured that they are connecting to a true originator of the incoming connection as the receiver can take advantage of existing public-key infrastructure to identify the other party, and utilize TLS' built-in encryption to ensure the confidentiality and integrity of communication. In other embodiments, alternative mechanisms may be implemented for providing this kind of security such as but not limited to: Secure Sockets Layer (SSL), and IPSEC.

In one embodiment, the mutual authentication procedure may be implemented using a lightweight XML remote-procedure-call protocol. In such an embodiment, an authentication method may utilize URLs. Invalid authentication requests can lead to connection attempts to web servers that consume bandwidth and computational time. In some embodiments, the use of secret keys is an alternative mechanism for authentication between authorized third-party extensions and the platform.

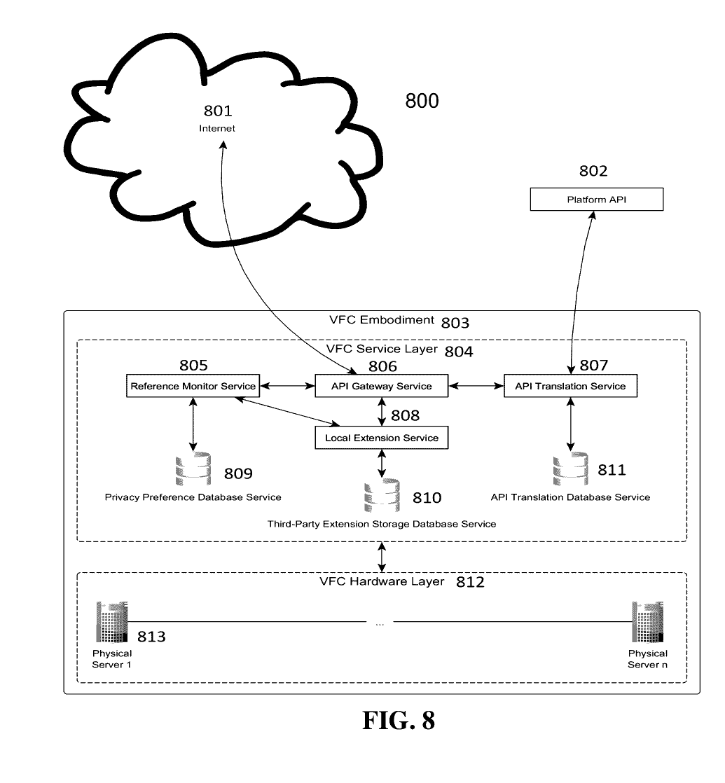

Referring to FIG. 8, a functional block diagram of an exemplary web application platform configuration 800 is shown, according to an embodiment of the invention. The exemplary web application platform configuration 800 comprises a web application platform 803, which comprises a web application service layer 804 and hardware layer 812. In one embodiment, the web application platform configuration 800 may be provided to allow for implementation or deployment of private information protection functionality for an existing application platform utilizing an API and an external extension component, such as the exemplary existing application platform shown in FIG. 1, for example. In one such embodiment, the web application service layer 804 comprises an exemplary API gateway service 806, a reference monitor service 805, an API translation service 807 and a local extension component service 808. The API gateway service 806 is operable to provide and control access from the web application platform to networked systems or devices outside of the platform, such as through the internet 801 or another communication network, or through an internal connected computer environment such as within a shared file system in an embodiment directed to privacy protection in an internal network or environment. In one embodiment, the API gateway service 806 may desirably replace an existing extension API interface (such as API interface 106 in the exemplary existing application platform shown in FIG. 1), so as to provide for protection of private information for an existing application platform providing API access to an external third party extension. In one embodiment, the reference monitor service 805 is operable to determine which requests for information from a remote extension component are allowed and which are prohibited such as by accessing user privacy preference information which may be stored on an exemplary privacy preference database service 809, for example.

In one embodiment, the local extension service 808 may be operable to execute and/or run local extension components, such as within a restricted operating system (or restricted networked system) environment such as a sandbox or virtualization, and may also be operable to provide and control access to a third party extension storage database service 810, which may provide and control access to stored third party extension data. In one embodiment, the API translation service 807 is operable to translate third party extension component information requests made to a an existing platform API (such as Platform API 802 or existing platform API 106 in the existing application platform shown in FIG. 1) into requests suitable for the API gateway service 806 of the present private information protecting embodiment using translation information stored in API translation database service 811. The API translation service 807 may also be operable to interface with the Web application platform API 802 such as to ensure that third party extension information requests may be compatibly handled by the implementation or deployment of the private information protecting web application platform configuration 800, and may desirably provide for access to permitted platform resources and functions to a remote third party extension outside the web application platform 803.

In one embodiment, the web application hardware layer 812 may desirably provide for physical server resources on which the web application service platform 804 runs, represented by one or more physical computers such as physical server 813. In one such embodiment, web application service layer 804 may be run on any suitable number of physical machines such as physical server 813. In a particular embodiment, certain functions of web application service layer 804 may be run on an individual or combination of individual servers 813. In an alternative embodiment, the functions of web application service layer 804 may desirably be distributed or split across multiple physical servers, such as servers 1 to n, as shown in FIG. 8, for example.

In one embodiment, the exemplary web application platform configuration 800 may be applied to implement certain embodiments described above to desirably enable a user to limit the communication of private data to an external realm (such as external realm 801) outside the web application platform 803, while benefiting from the functionality developed by a third party extension developer. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope of the disclosed invention as expressed in the claims.

While the present invention and its various functional components and operational functions have been described in particular exemplary embodiments, the invention may also be implemented in hardware, software, firmware, middleware or a combination thereof and utilized in systems, subsystems, components or subcomponents thereof. In particular embodiments implemented in software, elements of the present invention may be instructions and/or code segments to perform the necessary tasks. The program or code segments may be stored in a machine readable medium, such as a processor readable, medium or a computer program product, or transmitted by a computer data signal embodied in a carrier wave, or a signal modulated by a carrier, over a transmission medium or communication link. The machine readable medium or processor readable medium may include any medium that can store or transfer information in a form readable and executable by a machine, for example a processor, computer, etc.

An embodiment of the present invention relates to a computer storage product with a computer-readable medium having computer code thereon for performing various computer-implemented operations. The computer-readable media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices including Flash RAM memory storage cards, sticks and chips, for example. Examples of computer code include machine code, such as produced by a compiler, and files containing higher-level code that are executed by a computer using an interpreter. For example, an embodiment of the invention may be implemented using HTML, HTML5, XML, JavaScript, Java, C#, C++, Objective C, Python, or other scripting, markup and/or programming languages and development tools. Another embodiment of the invention may be implemented in hardwired circuitry in place of, or in combination with, machine-executable software instructions.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof. Accordingly, the scope of the invention is to be construed in accordance with the substance defined by the following claims.

What is claimed is:

1. A computer-implemented method of preserving privacy of private user data using third party extensions on a web application platform, comprising executing on at least one computer processor the steps of:
receiving private and non-private user data from a user on the web application platform;
providing non-private user data to a remote extension component executing on a third party computer processor;
receiving remote extension data from the remote extension component and storing the remote extension data on a local extension cache on the web application platform;
providing private user data and remote extension data to a local extension component installed on the web application platform;
executing local extension component instructions in a restricted operating system environment on the web application platform and receiving local extension data from the local extension component; and
providing the local extension data to a user.

2. The computer-implemented method of preserving privacy of private user data using third party extensions on a web application platform according to claim 1, additionally comprising executing on at least one computer processor the step of:
storing private and non-private user data in a user database accessible by the web application platform.

3. The computer-implemented method of preserving privacy of private user data using third party extensions on a web application platform according to claim 1, wherein the restricted operating system environment is configured to prevent communication between the local extension component and any computer processor or electronic device outside the web application platform.

4. The computer-implemented method of preserving privacy of private user data using third party extensions on a web application platform according to claim 1, wherein the restricted operating system environment is configured to prevent transfer of private user data outside of the local extension cache.

5. The computer-implemented method of preserving privacy of private user data using third party extensions on a web application platform according to claim 1, wherein the restricted operating system environment comprises at least one of: a sandbox running natively on the web application platform; and a virtualized operating system environment executing on the web application platform.

6. The computer-implemented method of preserving privacy of private user data using third party extensions on a web application platform according to claim 1, additionally comprising executing on at least one computer processor the step of:
installing a local extension component on the web application platform wherein said installing comprises a mutual identity authentication between the third party remote extension component and the web application platform.

7. The computer-implemented method of preserving privacy of private user data using third party extensions on a web application platform according to claim 1, additionally comprising executing on at least one computer processor the step of:
receiving a permission from the user to access the private user data by the local extension component.

8. The computer-implemented method of preserving privacy of private user data using third party extensions on a web application platform according to claim 1, additionally comprising executing on at least one computer processor the step of:
receiving a permission from the user to access the non-private user data by the remote extension component.

9. The computer-implemented method of preserving privacy of private user data using third party extensions on a web application platform according to claim 1, additionally comprising executing on at least one computer processor the step of:
receiving a privacy policy comprising one or more privacy access rules for determining access to the private and non-private user data by the local and remote extension components.

10. The computer-implemented method of preserving privacy of private user data using third party extensions on a web application platform according to claim 1, additionally comprising executing on at least one computer processor the step of:
receiving updated remote extension data from the remote extension component and storing the updated remote extension data on a local extension cache on the web application platform for access by the local extension component.

11. A non-transitory computer-readable medium storing computer-executable instructions to implement a method of preserving privacy of private user data using third party extensions on a web application platform, comprising computer-executable instructions to:
receive private and non-private user data from a user on the web application platform;
provide non-private user data to a remote extension component executing on a third party or untrusted computer processor;
receive remote extension data from the remote extension component and store the remote extension data on a local extension cache on the web application platform;
provide private user data and remote extension data to a local extension component installed on the web application platform;
execute local extension component instructions in a restricted operating system environment on the web application platform and receive local extension data from the local extension component; and
provide the local extension data to a user.

12. The non-transitory computer-readable medium according to claim 11, wherein the method of preserving privacy of private user data using third party extensions on a web application platform additionally comprises executing on at least one computer processor the step of:
storing private and non-private user data in a user database accessible by the web application platform.

13. The non-transitory computer-readable medium according to claim 11, wherein the restricted operating system environment is configured to prevent communication between the local extension component and any computer processor or electronic device outside the web application platform.

14. The non-transitory computer-readable medium according to claim 11, wherein the restricted operating system environment is configured to prevent transfer of private user data outside of the local extension cache.

15. The non-transitory computer-readable medium according to claim 11, wherein the restricted operating system environment comprises at least one of: a sandbox running natively on the web application platform; and a virtualized operating system environment executing on the web application platform.

16. The non-transitory computer-readable medium according to claim 11, wherein the method of preserving privacy of private user data using third party extensions on a web application platform additionally comprises executing on at least one computer processor the step of:
installing a local extension component on the web application platform wherein said installing comprises a mutual identity authentication between the third party remote extension component and the web application platform.

17. The non-transitory computer-readable medium according to claim 11, wherein the method of preserving privacy of private user data using third party extensions on a web application platform additionally comprises executing on at least one computer processor the step of:
receiving a permission from the user to access the private user data by the local extension component.

18. The non-transitory computer-readable medium according to claim 11, wherein the method of preserving privacy of private user data using third party extensions on a web application platform additionally comprises executing on at least one computer processor the step of:
receiving a permission from the user to access the non-private user data by the remote extension component.

19. The non-transitory computer-readable medium according to claim 11, wherein the method of preserving privacy of private user data using third party extensions on a web application platform additionally comprises executing on at least one computer processor the step of:
receiving a privacy policy comprising one or more privacy access rules for determining access to the private and non-private user data by the local and remote extension components.

20. A system for preserving privacy of private user data using third party extensions on a web application platform, the system comprising:
at least one computer processor;
at least one network interface;
a non-transitory computer-readable memory module; and
computer-readable instructions stored in the computer-readable memory module, wherein the computer-readable instructions when executed, are operable to configure the at least one computer processor to:
receive private and non-private user data from a user on the web application platform;
provide non-private user data to a remote extension component executing on a third party computer processor;
receive remote extension data from the remote extension component and store the remote extension data on a local extension cache on the web application platform;
provide private user data and remote extension data to a local extension component installed on the web application platform;
execute local extension component instructions in a restricted operating system environment on the web application platform and receive local extension data from the local extension component; and
provide the local extension data to a user.
